(19) United States
(12) Patent Application Publication
(10) Pub. No.: US 2023/0397198 A1
(43) Pub. Date: Dec. 7, 2023

(54) SMALL DATA TRANSMISSION PROCEDURE TO RANDOM ACCESS PROCEDURE FALLBACK

(71) Applicant: NOKIA TECHNOLOGIES OY, Espoo (FI)

(72) Inventors: Samuli Turtinen, Ii (FI); Chunli Wu, Beijing (CN); Jussi-Pekka Koskinen, Oulu (FI)

(21) Appl. No.: 18/250,178

(22) PCT Filed: Oct. 21, 2020
(86) PCT No.: PCT/CN2020/122481

§ 371 Date: Apr. 21, 2023

(51) Int. Cl. H04W 72/1268; H04B 17/318; H04W 74/08

(52) U.S. Cl. CPC H04W 72/1268; H04W 74/0833; H04B 17/328

(57) ABSTRACT

Disclosed are example embodiments of methods and apparatuses supporting a small data transmission (SDT) procedure to random access (RA) procedure fallback. A method may comprise initiating a small data transmission (SDT) procedure for transmission of uplink data to a network device, determining if a condition is satisfied, and transitioning from the SDT procedure to another procedure for transmission of the uplink data when the condition is satisfied. The another procedure may be a random access (RA) procedure different from the SDT procedure.

### TECHNICAL FIELD

Various example embodiments described herein generally relate to communication technologies, and more particularly, to methods and apparatuses supporting a small data transmission (SDT) procedure to random access (RA) procedure fallback.

### BACKGROUND

5G NR supports an RRC_INACTIVE state, in which state UE may transmit small and infrequent (periodic and/or non-periodic) uplink data to the network. UE does not need to move to an RRC_CONNECTED state for each data transmission no matter how small and infrequent the data packets are.

### SUMMARY

A brief summary of example embodiments is provided below to provide basic understanding of some aspects of various example embodiments. It should be noted that this summary is not intended to identify key features of essential elements or define scopes of the example embodiments, and its sole purpose is to introduce some concepts in a simplified form as a preamble for a more detailed description provided below.

In a first aspect, an example embodiment of a user equipment (UE) is provided. The UE may comprise at least one processor and at least one memory including computer program code. The at least one memory and the computer program code are configured to, with the at least one processor, cause the UE to perform one or more actions. The one or more actions may comprise initiating a small data transmission (SDT) procedure for transmission of uplink data to a network device, determining if a condition is satisfied, and transitioning from the SDT procedure to another procedure for transmission of the uplink data when the condition is satisfied.

In a second aspect, an example embodiment of a network device is provided. The network device may comprise at least one processor and at least one memory including computer program code. The at least one memory and the computer program code are configured to, with the at least one processor, cause the network device to perform one or more actions. The one or more actions may comprise receiving a message from a user equipment (UE) comprising an indication of transitioning from a small data transmission (SDT) procedure to another procedure.

In a third aspect, an example embodiment of a network device is provided. The network device may comprise at least one processor and at least one memory including computer program code. The at least one memory and the computer program code are configured to, with the at least one processor, cause the network device to perform one or more actions. The one or more actions may comprise receiving, from a user equipment (UE), a message comprising a payload on a first uplink (UL) grant in a random access (RA) procedure, the payload comprising a first part of a transport block (TB) for a small data transmission (SDT) procedure different from the RA procedure.

In a fourth aspect, an example embodiment of a method implemented at a user equipment (UE) is provided. The method may comprise initiating a small data transmission (SDT) procedure for transmission of uplink data to a network device, determining if a condition is satisfied, and transitioning from the SDT procedure to another procedure for transmission of the uplink data when the condition is satisfied.

In a fifth aspect, an example embodiment of a method implemented at a network device is provided. The method may comprise receiving a message from a user equipment (UE) comprising an indication of transitioning from a small data transmission (SDT) procedure to another procedure.

In a sixth aspect, an example embodiment of a method implemented at a network device is provided. The method may comprise receiving, from a user equipment (UE), a message comprising a payload on a first uplink (UL) grant in a random access (RA) procedure, the payload comprising a first part of a transport block (TB) for a small data transmission (SDT) procedure different from the RA procedure.

In a seventh aspect, an example embodiment of a computer program is provided. The computer program may comprise instructions stored on a computer readable medium. The instructions may, when executed by at least one processor of a user equipment (UE), cause the UE to perform one or more actions. The one or more actions may comprise initiating a small data transmission (SDT) procedure for transmission of uplink data to a network device, determining if a condition is satisfied, and transitioning from the SDT procedure to another procedure for transmission of the uplink data when the condition is satisfied.

In an eighth aspect, an example embodiment of a computer program is provided. The computer program may comprise instructions stored on a computer readable medium. The instructions may, when executed by at least one processor of a network device, cause the network device to perform one or more actions. The one or more actions may comprise receiving a message from a user equipment (UE) comprising an indication of transitioning from a small data transmission (SDT) procedure to another procedure.

In a ninth aspect, an example embodiment of a computer program is provided. The computer program may comprise instructions stored on a computer readable medium. The instructions may, when executed by at least one processor of a network device, cause the network device to perform one or more actions. The one or more actions may comprise receiving, from a user equipment (UE), a message comprising a payload on a first uplink (UL) grant in a random access (RA) procedure, the payload comprising a first part of a transport block (TB) for a small data transmission (SDT) procedure different from the RA procedure.

In a tenth aspect, an example embodiment of an apparatus is provided. The apparatus may comprise means for initiating a small data transmission (SDT) procedure for transmission of uplink data to a network device, means for determine if a condition is satisfied, and means for transitioning from the SDT procedure to another procedure for transmission of the uplink data when the condition is satisfied.

In an eleventh aspect, an example embodiment of an apparatus is provided. The apparatus may comprise means for receiving a message from a user equipment (UE) comprising an indication of transitioning from a small data transmission (SDT) procedure to another procedure.

In a twelfth aspect, an example embodiment of an apparatus is provided. The apparatus may comprise means for receiving, from a user equipment (UE), a message comprising a payload on a first uplink (UL) grant in a random access (RA) procedure, the payload comprising a first part of a transport block (TB) for a small data transmission (SDT) procedure, the RA procedure being different from the SDT procedure.

Other features and advantages of the example embodiments of the present disclosure will also be apparent from the following description of specific example embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example communication network.

FIG. 2 is a signaling diagram illustrating a four-step random access (RA) procedure.

FIG. 3 is a signaling diagram illustrating a two-step RA procedure.

FIG. 4 is a signaling diagram illustrating a small data transmission (SDT) procedure to another procedure fallback in accordance with some example embodiments.

FIG. 5 is a signaling diagram illustrating operations in case of the SDT to RA fallback in accordance with some example embodiments.

FIG. 6 is a signaling diagram illustrating operations in case of the SDT to RA fallback in accordance with some example embodiments.

FIG. 7 is a flow chart illustrating a method implemented at a terminal device in accordance with some example embodiments.

FIG. 8 is a flow chart illustrating a method implemented at a network device in accordance with some example embodiments.

FIG. 9 is a flow chart illustrating a method implemented at a network device in accordance with some example embodiments.

FIG. 10 is a block diagram illustrating an example communication system in which example embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

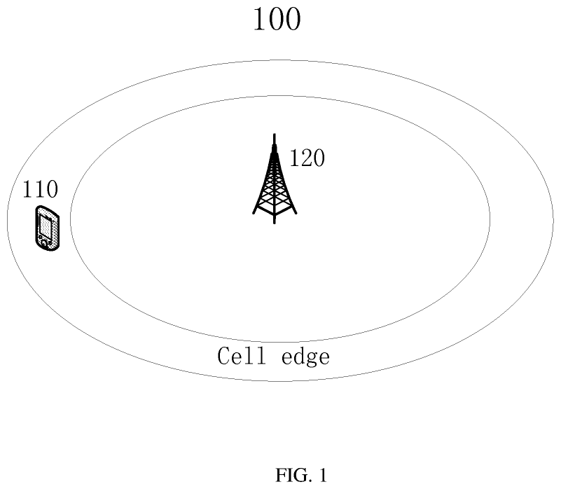

FIG. 1 illustrates a schematic diagram of an example communication network 100. Referring to FIG. 1, the communication network 100 may include a user equipment (UE) 110 and a base station (BS) such as gNB 120. The BS 120 may serve a cell, and the UE 110 may camp on the cell. When the UE 110 has merely small and infrequent data transmissions, the BS 120 may maintain the UE 110 in an RRC_INACTIVE state, in which state the UE 110 may transmit small data over a two-step or four-step random access channel (RACH) procedure or on a pre-configured uplink grant. When the small data transmission (SDT) is performed over the RACH procedure, the UE 110 may transmit an SDT transport block (TB) in a first message (MsgA) for the two-step RACH procedure or in a third message (Msg3) in the four-step RACH procedure to the BS 120.

Channel quality of the UE 110 may vary in the cell. For example, when the UE 110 moves from a central region to an edge region of the cell or when a beam for the UE 110 is at least partially blocked by a building or a moving object, reference signal received power (RSRP) and signal to interference plus noise ration (SINR) measured at the UE 110 may deteriorate. The deteriorated channel quality may not meet requirements for the SDT transmission. If the UE 110 has triggered a SDT procedure and the RSRP falls below a threshold, the SDT procedure may fail to transmit a transport block (TB) to the BS 120, causing the UE 110 to enter into an RRC_IDLE state. It would take more time for the UE 110 to establish an RRC connection with the BS 120 from the RRC_IDLE state compared to the RRC_INACTIVE state. In addition, the UE 110 would lose the TB generated in the SDT procedure.

Hereinafter, example embodiments of method and apparatus supporting an SDT to RA procedure fallback would be discussed in detail with reference to the drawings. In the example embodiments, the UE may transition from the SDT procedure to another procedure such as an RA procedure different from the SDT procedure when a certain condition is satisfied. The transport block (TB) generated in the SDT procedure may be transmitted to the network by virtue of the RA procedure, thereby increasing probability of successfully transmitting uplink data to the network.

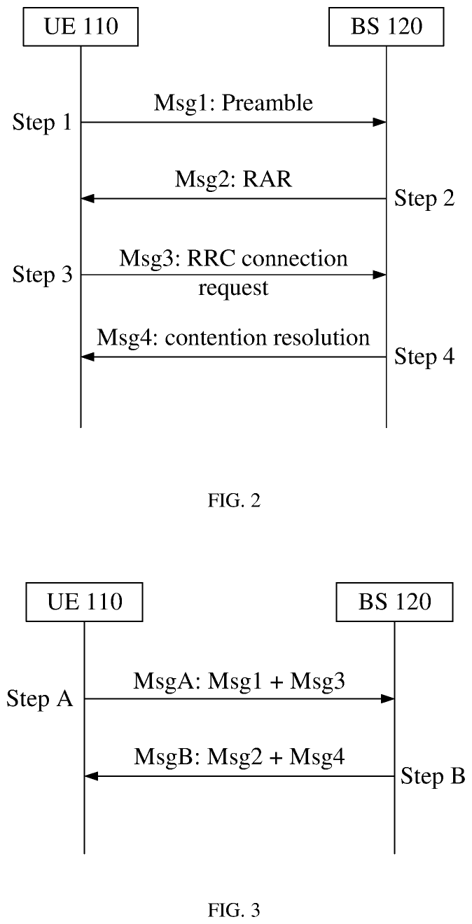

FIG. 2 is a signaling diagram illustrating a four-step random access (RA) procedure. As shown in FIG. 2, in Step 1, the UE 110 may transmit a first message (Msg1) including a preamble on a physical random access channel (PRACH) to the BS 120. The preamble may be selected from a preamble group such as a preamble group A or a preamble group B. In Step 2, the BS 120 may respond with a random access response (RAR) message (Msg2) to the UE 110. The Msg2 message may include a timing advance (TA) and an uplink (UL) grant on a physical downlink shared channel (PDSCH). In response to Msg2, the UE 110 sends to the BS 120 a third message (Msg3) using the UL grant in Step 3. The Msg3 message may include an RRC connection request on a physical uplink shared channel (PUSCH). The BS 120 then respond in Step 4 with a fourth message (Msg4) which may include a contention resolution on the PDSCH channel. It would be appreciated that the Msg2 message and the Msg4 message may further include a physical downlink control channel (PDCCH) communication carrying control information for decoding the PDSCH communication.

FIG. 3 illustrates a two-step RA procedure, which can accelerate access to the network compared to the four-step procedure shown in FIG. 2. Referring to FIG. 3, in Step A, the UE 110 may send to the BS 120 a first message (MsgA) combining Msg1 and Msg3 in the four-step procedure. That is, MsgA may include a preamble on the PRACH channel and an RRC message, e.g. RRC connection or resume request on the PUSCH channel. For non-RRC based SDT, MsgA may not include the RRC message but may include, e.g., uplink data. The RRC connection request may be transmitted using a pre-configured uplink grant. In response to MsgA, the BS 120 sends a second message (MsgB) combining Msg2 and Msg4 in the four-step procedure to the UE 110 in Step B. That is, MsgB may include a random access response (RAR) and a contention resolution on the PDSCH channel. Compared with the four-step procedure shown in FIG. 2, the two-step procedure can reduce the time length of the whole random access procedure.

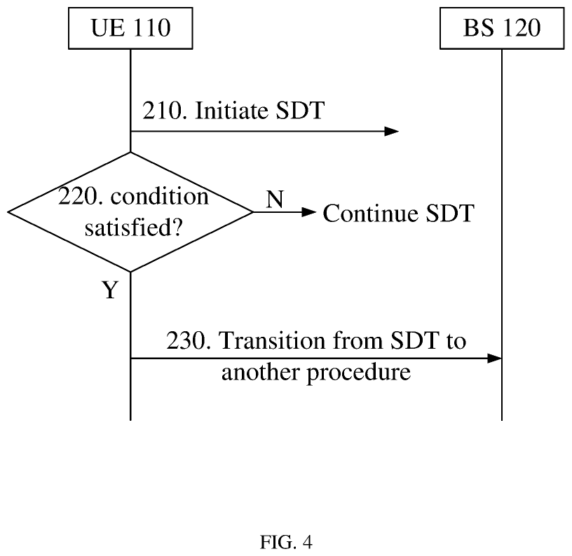

FIG. 4 is a signaling diagram illustrating an SDT procedure to another procedure fallback procedure in accordance with some example embodiments. Referring to FIG. 4, at Operation 210, the UE 110, which may be maintained in the RRC_INACTIVE state, may initiate an SDT procedure to transmit uplink data to the BS 120. In the SDT procedure, the UE 110 may package the uplink data into a transport block (TB) and attempt to transmit the TB to the BS 120. The SDT procedure may be performed over a two-step RA procedure shown in FIG. 3 or a four-step RA procedure shown in FIG. 2 or on a pre-configured UL grant. In the four-step RA procedure, the SDT uplink data may be transmitted in the Msg3 message to the network. In the two-step RA procedure, the SDT uplink data may be transmitted in the MsgA message to the network.

At Operation 220, the UE 110 may determine if a condition for an SDT procedure to another procedure fallback is satisfied. If the condition is not satisfied, the UE 110 may continue to perform the SDT procedure to transmit the SDT TB to the BS 120. The UE 110 may stay in the inactive state when an SDT attempt fails. Additionally or alternatively, the UE 110 may enter into an idle state when a predetermined number of SDT attempts have failed. If the condition is satisfied and the SDT procedure has not yet successfully transmitted the uplink data to the BS 120, the UE 110 may fallback at Operation 230 from the SDT procedure to another procedure in order to transmit the uplink data to the BS 120. The another procedure may be a random access (RA) procedure different from the SDT procedure. In other words, the RACH resources and/or preambles configured for the UE 110 in the RA procedure after the fallback are different from resources and/or preambles configured in the SDT procedure before the fallback. For example, the UE 110 may fallback from an SDT procedure performed over an RA procedure or on a pre-configured UL grant to a normal RA procedure. The normal RA procedure differs from the SDT RA procedure in that the SDT RA procedure transmits uplink data in MsgA or Msg3, while the normal RA procedure does not transmit uplink data to the network in MsgA or Msg3. In another example, the normal RA procedure differs from the SDT RA procedure in that the SDT RA procedure may be able to transmit more uplink data in MsgA or Msg3 than the normal RA procedure. As another example, the UE 110 may fallback from an SDT procedure performed on a pre-configured UL grant to an SDT RA procedure, or from an SDT procedure performed over a two-step RA procedure to a four-step SDT RA procedure. The UE 110 may transition to the two-step (normal or SDT) RA procedure shown in FIG. 3 by sending the MsgA message to the BS 120, or to the four-step (normal or SDT) RA procedure shown in FIG. 2 by sending the Msg1 message to the BS 120.

In some example embodiments, the UE 110 may determine in Operation 220 if reference signal received power (RSRP) measured at the UE 110 is lower than a first threshold to perform the SDT procedure. For example, when the UE 110 initiates the SDT procedure in Operation 210, the RSRP measured at the UE 110 may be equal to or larger than the first threshold. If the RSRP measured at a subsequent measurement occasion goes down lower than the first threshold, the UE 110 may decide to fallback from the SDT procedure to the RA procedure.

In some example embodiments, the UE 110 may determine in Operation 220 if the RSRP measured at the UE 110 is lower than the first threshold to perform the SDT procedure by an amount equal to or larger than a predetermined offset. For example, when the UE 110 initiates the SDT procedure in Operation 210, the RSRP measured at the UE 110 is equal to or larger than the first threshold. If the RSRP measured at a subsequent measurement occasion goes down lower than the first threshold but the difference therebetween is less than the predefined offset, the UE 110 may still perform the SDT procedure. When the RSRP measured at the UE 110 is lower than the first threshold by an amount equal to or larger than the predefined offset, the UE 110 may decide to fallback from the SDT procedure to the RA procedure. With the offset between the threshold to perform the SDT procedure and the threshold to transition from the SDT procedure to the RA procedure, the UE 110 may avoid frequent switching between the SDT procedure and the RA procedure.

In some example embodiments, the UE 110 may determine in Operation 220 if it has attempted to transmit the SDT TB a number of times in the SDT procedure. If the number of SDT attempts reaches a second threshold, the UE 110 may decide to fallback from the SDT procedure to the RA procedure.

In some example embodiments, the UE 110 may determine in Operation 220 if the RSRP measured at the UE 110 is lower than the first threshold for the second threshold number of SDT attempts. If so, the UE 110 may decide to fallback from the SDT procedure to the RA procedure.

In some example embodiments, the UE 110 may determine in Operation 220 if timing alignment for the UE 110 becomes invalid. For example, if a timing alignment timer expires when the SDT procedure is performed on a pre-configured UL grant, a low mobility criteria is not fulfilled, or the RSRP measured at the UE 110 differs from a reference value or range by an amount more than a threshold, the UE 110 may determine that the timing alignment becomes invalid and decide to fallback from the SDT procedure to the RA procedure.

In some example embodiment, the UE 110 may determine in Operation 220 if resources for the SDT transmission, for example a beam with SDT resources, become unavailable to the UE 110. In some examples, the beam with SDT resources may be the beam where the UE 110 initiated the SDT procedure. For example, the beam with SDT resources may be blocked by a building or a moving object. For example, the beam may become unavailable to the UE 110 when the measured RSRP and/or Reference Signal Received Quality (RSRQ) and/or SINR falls below a configured/pre-defined threshold level. In such a case, the UE 110 may decide to fallback from the SDT procedure to the RA procedure.

It would be appreciated that the UE 110 may also consider other conditions or a combination of two or more conditions in Operation 220 to decide if it needs to fallback from the SDT procedure to the RA procedure.

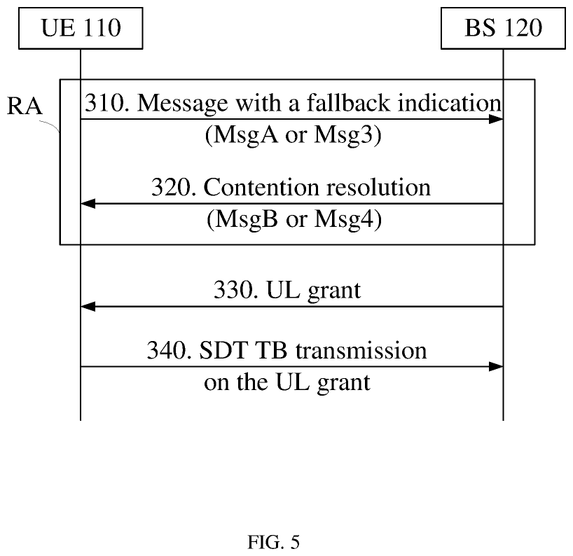

FIG. 5 is a signaling diagram illustrating operations in case of the SDT to RA fallback in accordance with some example embodiments. For example, if the UE 110 transitions from the SDT procedure to the RA procedure at Operation 230 in FIG. 4, the operations shown in FIG. 5 would be performed.

Referring to FIG. 5, at Operation 310 in the RA procedure, the UE 110 may send a message including an indication of the SDT to RA transition (fallback) to the BS 120. Here, the message may be a first message (MsgA) in the two-step RA procedure shown in FIG. 3 or a third message (Msg3) in the four-step RA procedure shown in FIG. 2.

In some example embodiments, the transition indication may include a buffer status report (BSR) indicating buffered data in a SDT buffer for the unsuccessful SDT procedure. For example, when the UE 110 decides to fallback from the SDT procedure to the RA procedure, it may introduce a BSR trigger. In response to the BSR trigger, the BSR report may be multiplexed into the MsgA or Msg3 message in the RA procedure. When the BS 120 receives the BSR report, it would know that the RA procedure originates from the SDT to RA procedure fallback, and the BS 120 would further knows the data size in the SDT buffer that the UE 110 needs to transmit to the BS 120.

In some example embodiments, the transition indication may include a newly introduced medium access control (MAC) control element (CE) and/or MAC subheader. The MAC subheader may include a specific logical channel identifier (LCID) to identify the SDT to RA procedure transition. In some examples, the MAC subheader with the specific LCID may not have a corresponding MAC CE or MAC service data unit (SDU) in a MAC subPDU. When the BS 120 knows from the MAC CE and/or MAC subheader that the RA procedure originates from the SDT to RA fallback, it can estimate the data size the UE 110 needs to transmit to the BS 120, i.e., the data size of a SDT TB.

In some example embodiments, the MAC CE and/or MAC subheader may indicate a preamble group used in the SDT procedure. If the SDT procedure is performed over a two-step or four-step RACH procedure, generally a preamble group A would be used for transmission of a relatively smaller data volume, and a preamble group B would be used for transmission of a relatively larger data volume. Then, from the preamble group used in the SDT procedure, the BS 120 can deduce the data volume the UE 110 needs to transmit to the BS 120.

In some example embodiments, the MAC CE and/or MAC subheader may indicate a resource index such as a transport block size (TBS) index used to build the TB for the SDT transmission. From the TBS index, the BS 120 can deduce the data volume the UE 110 needs to transmit to the BS 120.

In some example embodiments, the transition indication may include a common control channel (CCCH) SDU from the SDT transmission. From the CCCH SDU for the SDT transmission, the BS 120 can deduce the SDT to RA fallback and in turn the data volume the UE 110 needs to transmit to the BS 120.

When the BS 120 knows the SDT to RA fallback from the transition indication, the BS 120 could allocate to the UE 110 an UL grant that can accommodate an SDT TB. Then the SDT TB which the UE 110 failed to transmit to the BS 120 in the SDT procedure may be transmitted on the allocated UL grant. The UE 110 may store the SDT TB in a MAC buffer, and it does not need to rebuild the SDT TB as the allocated UL grant is able to accommodate the SDT TB.

In some example embodiments, the message may further include a random number as an identifier (ID) of the UE 110 in the fallback RA procedure. The random number may be generated by the UE 110 and included in an MAC CE that has a size equal to a C-RNTI MAC CE (e.g., 16 bits). The random number MAC CE may have a special LCID to avoid being mistaken as the C-RNTI MAC CE. For example, the special LCID for the random number MAC CE may be the transition indication LCID as discussed above.

In some example embodiments, the message may alternatively include the CCCH SDU from the SDT transmission to identify the UE 110. Similar to the random number MAC CE, the CCCH SDU may have a special LCID.

In response to the message (MsgA or Msg3) received in Operation 310, the BS 120 may send a message including a contention resolution to the UE 110 in Operation 320. The message sent in Operation 320 may be a second message (MsgB) in the two-step RA procedure shown in FIG. 3 or a fourth message (Msg4) in the four-step RA procedure shown in FIG. 2. If the message received in Operation 310 includes a UE ID represented by the random number or the CCCH SDU from the SDT transmission, the contention resolution included in the message sent in Operation 320 may be generated based on the random number or the CCCH SDU from the SDT transmission.

In some example embodiments, when the RA procedure is successfully implemented, the BS 120 may move the UE 110 to the RRC_CONNECTED state, and an RRC connection may be established between the UE 110 and the BS 120. In some example embodiments, the BS 120 may still maintain the UE 110 in the RRC_INACTIVE state as the BS 120 knows that the RA procedure originates from the SDT to RA fallback. Then in Operation 330, the BS 120 may allocate a UL grant to the UE 110 on a physical downlink control channel (PDCCH). As the BS 120 is aware of the data size that the UE 110 needs to transmit, it would allocate a UL grant large enough to accommodate the data size for example an SDT TB to the UE 110. In response to the allocated UL grant, the UE 110 would transmit the SDT TB on the UL grant to the BS 120 in Operation 340. In the example embodiments, the SDT TB that the UE 110 failed to transmit to the BS 120 in the SDT procedure would be transmitted to the BS 120 by virtue of the RA procedure, and the UE 110 does not need to rebuild the SDT TB.

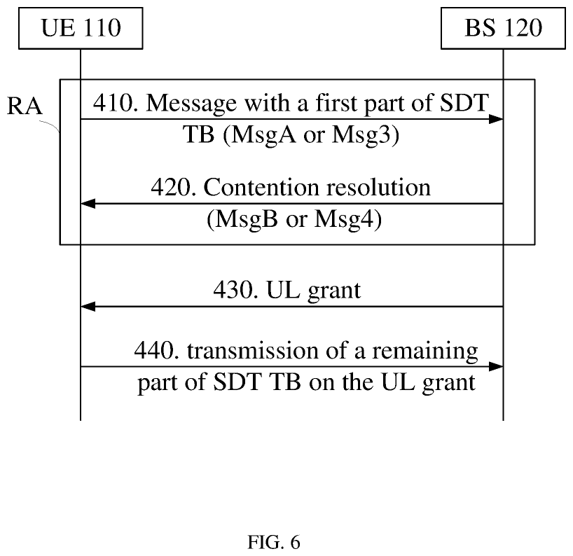

FIG. 6 is a signaling diagram illustrating operations in case of the SDT to RA fallback in accordance with some example embodiments. For example, if the UE 110 transitions from the SDT procedure to the RA procedure at Operation 230 in FIG. 4, the operations shown in FIG. 6 would be performed. In the procedure shown in FIG. 6, the SDT TB that the UE 110 failed to transmit to the BS 120 may be rebuilt and transmitted to the BS 120 by virtue of the RA procedure.

Referring to FIG. 6, at Operation 410 in the RA procedure, the UE 110 may send a message including a first part of the SDT TB to the BS 120. The message sent in Operation 410 may be a first message (MsgA) in the two-step RA procedure shown in FIG. 3 or a third message (Msg3) in the four-step RA procedure shown in FIG. 2. The first part of the SDT TB may be sent on a first UL grant in the RA procedure. If the message sent in Operation 410 is the first message (MsgA) in the two-step RA procedure, the first part of the SDT TB may be sent on a pre-configured UL grant; if the message sent in Operation 410 is the third message (Msg3) in the four-step RA procedure, the first part of the SDT TB may be sent on a UL grant received in the second message (Msg2).

In some example embodiments, the first part of the SDT TB sent in Operation 410 may include the CCCH SDU from the SDT TB. As discussed above, the CCCH SDU may also indicate that the RA procedure originates from an SDT to RA fallback, or the CCCH SDU may have a special LCID to indicate the SDT TO RA fallback. Remaining SDU(s) and MAC CE(s) of the SDT TB may be transmitted on a subsequent UL grant(s). In some example embodiments, the first part of the SDT TB may include the CCCH SDU as well as additional SDU(s) and/or MAC CE(s) from the SDT TB to a point that the UL grant for the message is exhausted, and the rest SDU(s) and/or MAC CE(s) of the SDT TB may be transmitted in a subsequent UL grant(s).

In some example embodiments, the UE 110 may select a preamble group and in turn a preamble from the preamble group for the RA procedure. The preamble may be transmitted in the MsgA message or in the Msg1 message in the RA procedure. When selecting the preamble group, the UE 110 may take into account the payload of CCCH SDU from the SDT TB, which enables selection of the preamble group A. If the whole SDT TB is taken into account for the preamble group selection, the UE 110 would likely always select the preamble group B as the SDT TB is relatively large.

In response to the message received in Operation 410, the BS 120 may send a message including a contention resolution to the UE 110 in Operation 420. The message sent in Operation 420 may be a second message (MsgB) in the two-step RA procedure shown in FIG. 3 or a fourth message (Msg4) in the four-step RA procedure shown in FIG. 2.

In some example embodiments, when the RA procedure is successfully implemented, the BS 120 may move the UE 110 to the RRC_CONNECTED state, and an RRC connection may be established between the UE 110 and the BS 120. In some example embodiments, the BS 120 may still maintain the UE 110 in the RRC_INACTIVE state as the BS 120 knows from the CCCH SDU that the RA procedure originates from the SDT to RA fallback. Then in Operation 430, the BS 120 may allocate a UL grant to the UE 110 on a PDCCH channel. As the BS 120 is aware of the data size that the UE 110 needs to transmit according to the CCCH SDU from the SDT TB, it may allocate a UL grant capable of accommodating the remaining part of the SDT TB to the UE 110. In response to the allocated UL grant, the UE 110 would transmit the remaining part of the SDT TB on the UL grant to the BS 120 in Operation 440. In such a way, the SDT TB is rebuilt at the UE 110 and transmitted to the BS 120 on plural UL grants.

In the above example embodiments, the UE 110 may fallback from the SDT procedure to the RA procedure when a certain condition is satisfied, and a first SDT transmission may be transmitted to the BS 120 by the RA procedure. If the RA procedure is successful, the BS 120 may move the UE 110 to the RRC_CONNECTED state or maintain the UE 110 in the RRC_INACTIVE state. Then the SDT TB that the UE 110 failed to transmit in the SDT procedure may be transmitted on a subsequent UL grant(s) to the BS 120. The SDT TB may or may not be rebuilt at the UE 110 for transmission to the BS 120.

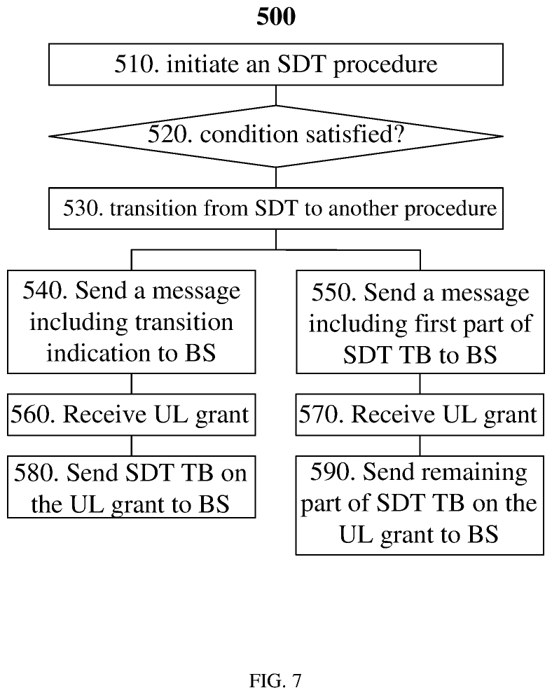

FIG. 7 is a flow chart illustrating a method 500 in accordance with some example embodiments. The method 500 may be implemented at a terminal device such as the UE 110 shown in FIG. 1. For example, steps of the method 500 may be performed by means, modules or elements of an apparatus implemented at the UE 110. Some details of the method 500 have been discussed above with reference to the procedures shown in FIGS. 2-6, and a brief description of the method 500 will be give here. For a better understanding, the below description of the method 500 may be read with reference to the above description relating to FIGS. 2-6.

Referring to FIG. 7, the method 500 may include a step 510 of initiating an SDT procedure for transmission of uplink data to a network device such as the BS 120. In the SDT procedure, the UE 110 may be in the RRC_INACTIVE state, and it may package the uplink data in a transport block (TB) for the SDT transmission. When an SDT attempt fails, the UE may stay in the RRC_INACTIVE state and try a next SDT attempt. In some example embodiments, if a predetermined number of SDT attempts have failed, the UE may enter into the RRC_IDLE state.

The method 500 may further include a step 520 of determining if a condition is satisfied. In some example embodiments, the condition may include one or more of following conditions:
Reference signal received power (RSRP) measured at the UE is lower than a first threshold;
The RSRP measured at the UE is lower than the first threshold by more than a predetermined offset;
A number of SDT attempts reaches a second threshold;
The RSRP measured at the UE is lower than the first threshold for the second threshold number of SDT attempts;
Timing alignment for the UE becomes invalid; and
A beam with SDT resources becomes unavailable to the UE.

If the condition is satisfied, then in a step 530, the UE may transition from the SDT procedure to another procedure such as an RA procedure different from the SDT procedure.

The RA procedure may be implemented in various ways. In some example embodiments, the method 500 may include a step 540 of sending a message comprising an indication of the SDT to RA transition to the network device in the RA procedure. The message may be a first message (MsgA) in a two-step RA procedure or a third message (Msg3) in a four-step RA procedure. In some example embodiments, the transition indication may include a buffer status report (BSR) indicating buffered data for the SDT transmission. For example, when the UE transitions from the SDT procedure to the RA procedure in the step 530, the UE may further introduce a BSR trigger, in response to which the BSR report may be multiplexed into the RA message sent in the step 540.

In some example embodiments, the transition indication may include a medium access control (MAC) control element (CE) and/or a logical channel identifier (LCID) in an MAC subheader. The MAC CE and/or the LCID may indicate for example the transitioning, a preamble group used for the SDT transmission, or a transport block size (TBS) index used to build a transport block (TB) including the uplink data for the SDT transmission.

In some example embodiments, the transition indication may include a common control channel (CCCH) service data unit (SDU) from the SDT transmission.

In some example embodiments, the message sent in the step 540 may further include a random number generated at the UE or a CCCH SDU from the SDT transmission for identifying the UE. Although not shown in FIG. 7, the UE may receive from the network device a message including a contention resolution in the RA procedure, and the contention resolution may be generated based on the random number or the CCCH SDU from the SDT transmission.

The method 500 may further include a step 560 of receiving, after the RA procedure, a UL grant from the network device. As the network device knows from the transition indication that the UE attempted to transmit uplink data by the SDT procedure, the network device would allocate the UL grant capable of accommodating the SDT TB.

In response to the UL grant received in the step 560, the UE may transmit the TB including the uplink data generated in the SDT procedure on the UL grant to the network device in a step 580. The SDT TB including the uplink data may be stored in an MAC buffer of the UE.

In some example embodiments, the RA procedure may be implemented by sending a message comprising a payload on a first uplink (UL) grant to the network device in a step 550. The payload may include a first part of a transport block (TB) including the uplink data generated in the SDT procedure. The message may be a first message (MSGA) in a two-step RA procedure or a third message (Msg3) in a four-step RA procedure. The first part of the SDT TB may include at least a CCCH SDU from the TB. The first part may further include additional MAC SDU(s) and/or MAC CE(s) to a point that the UL grant for the message is exhausted.

In the RA procedure, the UE would select a preamble group and in turn a preamble from the preamble group and transmit the preamble to the network device in the MsgA or Msg1 message shown in FIGS. 2-3. In some example embodiments, the UE may select the preamble group for the RA procedure based on the CCCH SDU from the TB. It would enable selection of the preamble group A as the UE would likely always select the preamble group B if the whole SDT TB is taken into account.

Referring to FIG. 7, the method 500 may further include a step 570 of receiving a UL grant from the network device and a step 590 of transmitting a remaining part of the SDT TB on the UL grant. Thus, the remaining part of the SDT TB may be transmitted on one or more subsequent UL grants.

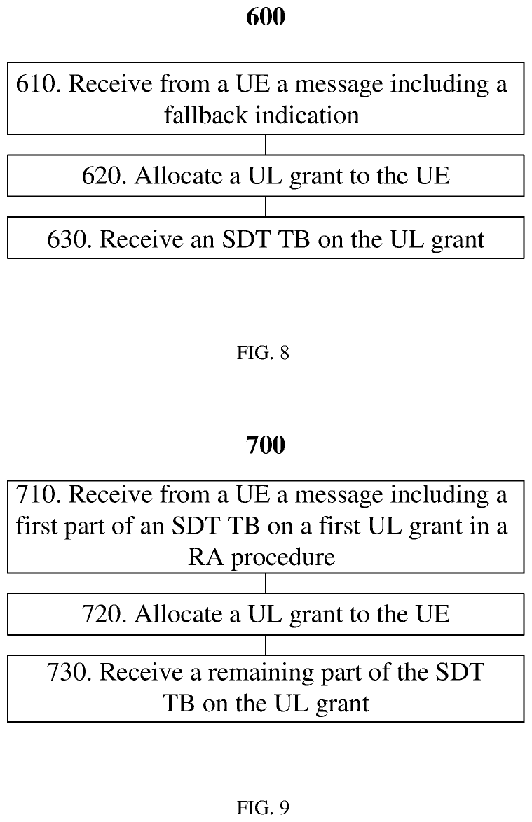

FIG. 8 is a flow chart illustrating a method 600 in accordance with some example embodiments. The method 600 may be implemented at a network device such as the BS 120 shown in FIG. 1. For example, steps of the method 600 may be performed by means, modules or elements of an apparatus implemented at the BS 120. Some details of the method 600 have been discussed above with reference to the procedures shown in FIGS. 2-7, and a brief description of the method 600 will be give here. For a better understanding, the below description of the method 600 may be read with reference to the above description relating to FIGS. 2-7.

Referring to FIG. 8, the method 600 may include a step 610 of receiving, in a random access (RA) procedure, a message including a fallback indication from a user equipment (UE) such as the UE 110. The fallback indication may indicate a fallback from an SDT procedure to another procedure such as an RA procedure different from the SDT procedure. The message may be a first message (MsgA) in a two-step RA procedure or a third message (Msg3) in a four-step RA procedure. In some example embodiments, the transition indication may include a buffer status report (BSR) indicating buffered data for an SDT transmission. In some example embodiments, the transition indication may include a medium access control (MAC) control element (CE) and/or a logical channel identifier (LCID) in an MAC subheader. The MAC CE and/or LCID may indicate the transitioning, a preamble group used for an SDT transmission, or a transport block size (TBS) index used to build a transport block (TB) for an SDT transmission. In some example embodiments, the transition indication may include a common control channel (CCCH) service data unit (SDU) from an SDT transmission.

In some example embodiments, the message received in the step 610 may further include a CCCH SDU from an SDT transmission or a random number for identifying the UE. Although not shown in FIG. 8, the network device may generate a contention resolution based on the CCCH SDU from the SDT transmission or the random number and send the contention resolution in the MsgB or Msg4 message to the UE.

Referring to FIG. 8, the method 800 may further include a step 620 of allocating a UL grant to the UE after the RA procedure. As the network device knows that the UE fell back from the SDT procedure to the RA procedure, the UL grant allocated in the step 620 may be large enough to accommodate a TB for an SDT transmission.

Then in a step 630, the network device may receive a TB on the allocated UL grant from the UE. In this way, the TB generated in the SDT procedure may be transmitted to the network device by virtue of the RA procedure.

FIG. 9 is a flow chart illustrating a method 700 in accordance with some example embodiments. The method 700 may be implemented at a network device such as the BS 120 shown in FIG. 1. For example, steps of the method 700 may be performed by means, modules or elements of an apparatus implemented at the BS 120. Some details of the method 700 have been discussed above with reference to the procedures shown in FIGS. 2-7, and a brief description of the method 700 will be give here. For a better understanding, the below description of the method 700 may be read with reference to the above description relating to FIGS. 2-7.

Referring to FIG. 9, the method 700 may include a step 710 of receiving, from a user equipment (UE), a message comprising a payload on a first uplink (UL) grant in a random access (RA) procedure. The message may be a first message (MsgA) in a 2-step RA procedure or a third message (Msg3) in a 4-step RA procedure. The payload may include a first part of a transport block (TB) for a small data transmission (SDT). For example, the first part of the TB may include at least a common control channel (CCCH) service data unit (SDU) from the TB. In some example embodiments, the first part of the TB may further include additional MAC CE(s) and/or MAC SDU(s) from the TB.

The method 700 may further include a step 720 of allocating a UL grant to the UE. For example, the network device may send the UL grant on a PDCCH channel to the UE.

Then in a step 730, the network device may receive a remaining part of the TB on the allocated UL grant from the UE. In this way, the TB generated in the SDT procedure may be transmitted to the UE by virtue of the RA procedure.

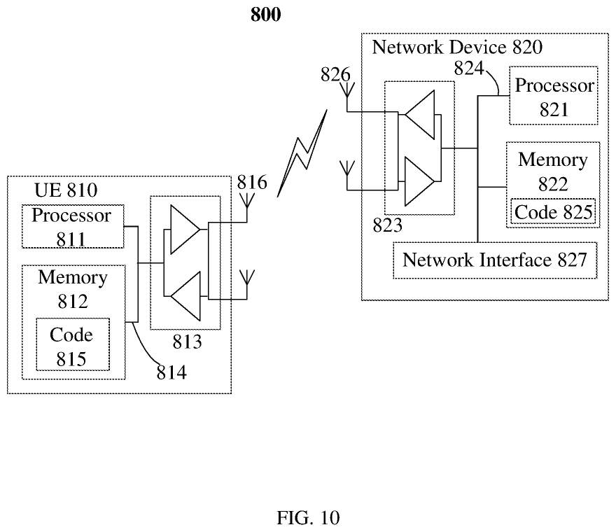

FIG. 10 is a block diagram illustrating an example communication system 800 in which example embodiments of the present disclosure can be implemented. As shown in FIG. 10, the communication system 800 may include a user equipment (UE) 810 which may be implemented as the UE 110 discussed above, and a network device 820 which may be implemented as the BS 120 discussed above. Although FIG. 10 shows only one UE 810, it would be appreciated that the communication system 800 may comprise a plurality of UEs 810 that wirelessly connect to the network device 820.

Referring to FIG. 10, the UE 810 may comprise one or more processors 811, one or more memories 812 and one or more transceivers 813 interconnected through one or more buses 814. The one or more buses 814 may be address, data, or control buses, and may include any interconnection mechanism such as series of lines on a motherboard or integrated circuit, fiber, optics or other optical communication equipment, and the like. Each of the one or more transceivers 813 may comprise a receiver and a transmitter, which are connected to one or more antennas 816. The UE 810 may wirelessly communicate with the network device 820 through the one or more antennas 816. The one or more memories 812 may include computer program code 815. The one or more memories 812 and the computer program code 815 may be configured to, when executed by the one or more processors 811, cause the user equipment 810 to perform processes and steps relating to the UE 110 as described above.

The network device 820 may comprise one or more processors 821, one or more memories 822, one or more transceivers 823 and one or more network interfaces 827 interconnected through one or more buses 824. The one or more buses 824 may be address, data, or control buses, and may include any interconnection mechanism such as a series of lines on a motherboard or integrated circuit, fiber, optics or other optical communication equipment, and the like. Each of the one or more transceivers 823 may comprise a receiver and a transmitter, which are connected to one or more antennas 826. The network device 820 may operate as a base station for the UE 810 and wirelessly communicate with the UE 810 through the one or more antennas 826. The one or more network interfaces 827 may provide wired or wireless communication links through which the network device 820 may communicate with other network devices, entities or functions. The one or more memories 822 may include computer program code 825. The one or more memories 822 and the computer program code 825 may be configured to, when executed by the one or more processors 821, cause the network device 820 to perform processes and steps relating to the BS 120 as described above.

The one or more processors 811, 821 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 811, 821 may be configured to control other elements of the UE/network device and operate in cooperation with them to implement the procedures discussed above.

The one or more memories 812, 822 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 812, 822 may include but not limited to an electric, a magnetic, an optical, an electromagnetic, an infrared, or a semiconductor system, apparatus, or device or any combination of the above.

The network device 820 can be implemented as a single network node, or disaggregated/distributed over two or more network nodes, such as a central unit (CU), a distributed unit (DU), a remote radio head-end (RRH), using different functional-split architectures and different interfaces.

It would be understood that blocks in the drawings may be implemented in various manners, including software, hardware, firmware, or any combination thereof. In some example embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some example embodiments further provide computer program code or instructions which, when executed by one or more processors, may cause a device or apparatus to perform the procedures described above. The computer program code for carrying out procedures of the example embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some example embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single example embodiment. Conversely, various features that are described in the context of a single example embodiment may also be implemented in multiple example embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

Abbreviations used in the description and/or in the figures are defined as follows:
BS Base Station
BSR Buffer Status Report
C-RNTI Cell-Radio Network Temporary Identifier
gNB nest Generation Base Station
LCID Logical Channel Identifier
MAC Medium Access Control
Msg Message
NR New Radio
PDCCH Physical Downlink Control Channel
PDSCH Physical Downlink Shared Channel
PRACH Physical Random Access Channel
RACH Random Access Channel
RAR Random Access Response
RRC Radio Resource Control
RSRP Reference Signal Received Power
SDT Small Data Transmission
TA Timing Advance
UE User Equipment

1. A user equipment (UE) comprising:
at least one processor; and
at least one memory including computer program code, the at least one memory and the computer program code configured to, with the at least one processor, cause the UE to:
initiate a small data transmission (SDT) procedure for transmission of uplink data to a network device;
determine if a condition is satisfied; and
transition from the SDT procedure to another procedure for transmission of the uplink data when the condition is satisfied.

2. The UE of claim 1 wherein the condition comprises one or more of following conditions:
reference signal received power (RSRP) measured at the UE is lower than a first threshold;
the RSRP measured at the UE is lower than the first threshold by more than a predetermined offset;
a number of SDT attempts reaches a second threshold;
the RSRP measured at the UE is lower than the first threshold for the second threshold number of SDT attempts;
timing alignment for the UE becomes invalid; and
a beam with SDT resources becomes unavailable to the UE.

3. The UE of claim 1 wherein the another procedure is a random access (RA) procedure different from the SDT procedure;
wherein the UE is configured with random access channel (RACH) resources in the RA procedure different from those configured in the SDT procedure.

4. (canceled)

5. The UE of claim 3, wherein the message is a first message (MsgA) in a two-step RA procedure or a third message (Msg3) in a four-step RA procedure;
wherein the at least one memory and the computer program code are further configured to, with the at least one processor, cause the UE to:
send, in the RA procedure, a message comprising an indication of the transitioning to the network device.

6. (canceled)

7. The UE of claim 5 wherein the indication comprises a buffer status report (BSR) indicating buffered data for the SDT transmission.

8. The UE of claim 5 wherein the indication comprises a medium access control (MAC) control element (CE) or a logical channel identifier (LCID) in an MAC subheader to indicate:
the transitioning,
a preamble group used for the SDT transmission, or
a transport block size (TBS) index used to build a transport block (TB) including the uplink data for the SDT transmission.

9. The UE of claim 5 wherein the indication comprises a common control channel (CCCH) service data unit (SDU) from the SDT transmission.

10. The UE of claim 5 wherein the message further comprises:
a random number generated at the UE or a CCCH SDU from the SDT transmission for identifying the UE.

11. The UE of claim 10 wherein the at least one memory and the computer program code are further configured to, with the at least one processor, cause the UE to:
receive, in the RA procedure, a message comprising a contention resolution generated based on the random number or the CCCH SDU from the SDT transmission.

12. The UE of claim 5 wherein the at least one memory and the computer program code are further configured to, with the at least one processor, cause the UE to:
receive from the network device an uplink grant capable of accommodating a transport block (TB) including the uplink data generated in the SDT procedure; and
transmit the TB including the uplink data on the uplink grant to the network device.

13. The UE of claim 12 wherein the TB including the uplink data is stored in an MAC buffer.

14. The UE of claim 3 wherein the at least one memory and the computer program code are further configured to, with the at least one processor, cause the UE to:
send to the network device a message comprising a payload on a first uplink (UL) grant in the RA procedure, the payload including a first part of a transport block (TB) including the uplink data generated in the SDT procedure.

15. The UE of claim 14 wherein the message is a first message (MSGA) in a two-step RA procedure or a third message (Msg3) in a four-step RA procedure.

16. The UE of claim 14 wherein the first part of the TB comprises at least a CCCH SDU from the TB.

17. The UE of claim 16 wherein the at least one memory and the computer program code are further configured to, with the at least one processor, cause the UE to:
select a preamble group for the RA procedure based on the CCCH SDU from the TB.

18. The UE of claim 14 wherein the at least one memory and the computer program code are further configured to, with the at least one processor, cause the UE to:
transmit a remaining part of the TB on one or more subsequent UL grants.

19. The UE of claim 1 wherein the UE stays in an inactive state when an SDT attempt fails, and/or the UE enters into an idle state when a predetermined number of SDT attempts have failed.

20. A network device comprising:
at least one processor; and
at least one memory including computer program code, the at least one memory and the computer program code configured to, with the at least one processor, cause the network device to:
receive a message from a user equipment (UE) comprising an indication of transitioning from a small data transmission (SDT) procedure to another procedure.

21. The network device of claim 20 wherein the another procedure is a random access (RA) procedure different from the SDT procedure; and
wherein the message is a first message (MsgA) in the RA procedure when the RA procedure is a 2-step RA procedure or a third message (Msg3) in the RA procedure when the RA procedure is a 4-step RA procedure.

22-23. (canceled)

24. The network device of claim 20 wherein the indication comprises a medium access control (MAC) control element (CE) or a logical channel identifier (LCID) in an MAC subheader to indicate:
the transitioning,
a preamble group used for an SDT transmission, or
a transport block size (TBS) index used to build a transport block (TB) for an SDT transmission.

25-65. (canceled)
